(19) United States
(12) Patent Application Publication
(10) Pub. No.: US 2026/0154746 A1
(43) Pub. Date: Jun. 4, 2026

(54) PROCESSING METHOD, APPARATUS, ELECTRONIC DEVICE AND STORAGE MEDIUM FOR EQUITY INCENTIVE DATA

(71) Applicant: Shenzhen Futu Network Technology Co., Ltd., ShenZhen (CN)

(72) Inventors: Meiyue PANG, Shenzhen (CN); Wen Feng, Shenzhen (CN)

(73) Assignee: Shenzhen Futu Network Technology Co., Ltd., Shenzhen (CN)

(21) Appl. No.: 19/420,937

(22) Filed: Dec. 16, 2025

Related U.S. Application Data
(63) Continuation of application No. PCT/CN2025/133913, filed on Nov. 10, 2025.

(30) Foreign Application Priority Data
Nov. 29, 2024 (CN) 202411741775.4

(51) Int. Cl. G06Q 40/04

(52) U.S. Cl. CPC G06Q 40/045

(57) ABSTRACT

A processing method, an apparatus, an electronic device, and a storage medium for equity incentive data. The processing method includes: in response to a resource conversion request, acquiring initial equity incentive data of a target object; converting an initial option grant share and initial option vesting total shares under different vesting states according to the conversion information, to obtain a target option grant share and a target option vesting total; determining target option vesting sub-shares, based on a target option vesting total share, the initial option vesting sub-shares, and the conversion information; sending the target option grant share and a target option vesting sub-share of each of the vesting batches as target equity incentive data, to a first terminal device, and enabling the first terminal device to update the initial equity incentive data.

### CROSS-REFERENCE TO RELATED APPLICATIONS

This application is a continuation of International (PCT) Patent Application No. PCT/CN2025/133913, filed on Nov. 10, 2025, which claims priority to Chinese Patent Application No. 202411741775.4, filed on Nov. 29, 2024, entitled “PROCESSING METHOD, APPARATUS, ELECTRONIC DEVICE AND STORAGE MEDIUM FOR EQUITY INCENTIVE DATA”, the entire contents of which are incorporated herein by reference.

### TECHNICAL FIELD

The present disclosure relates to the technical field of information processing technologies, and in particular to a processing method, an apparatus, an electronic device, and a storage medium for equity incentive data.

### BACKGROUND

ESOP (Employee Stock Ownership Plans), also known as equity incentive, refers to a mechanism that allows employees to hold stocks and participate in a company's profit-sharing mechanism and decision-making process, thereby attracting, retaining, and motivating the employees of the company. Stock consolidation refers to an event of consolidating several old stocks into one new stock and increasing the par value per stock of the new stock accordingly. After a stock consolidation conducted by a listed company, in order to ensure that the rights and interests of company employees are not affected, it is usually necessary to correspondingly adjust the equity incentive data held by employees. However, in the related art, adjusting the equity incentive data held by employees requires a relatively complex adjustment and update process, resulting in low adjustment efficiency of the equity incentive data and low reliability of the adjusted equity incentive data.

### SUMMARY

In a first aspect, the present disclosure provides a processing method for equity incentive data, applied to a business server. The processing method includes the steps as follow. In response to a resource conversion request from a first terminal device, acquiring initial equity incentive data of a target object. The initial equity incentive data includes an initial option grant share and initial option vesting data under different vesting states. The initial option vesting data under different vesting states includes an initial option vesting total share under a corresponding vesting state and initial option vesting sub-shares of different vesting batches.

Acquiring conversion information corresponding to the resource conversion request, and converting the initial option grant share and initial option vesting total shares under different vesting states according to the conversion information, to obtain a target option grant share and target option vesting total shares under different vesting states.

For any target vesting state among the different vesting states, determining target option vesting sub-shares of different vesting batches, based on a target option vesting total share under the target vesting state, the initial option vesting sub-shares of different vesting batches, and the conversion information.

Sending the target option grant share and a target option vesting sub-share of each of the vesting batches under the different vesting states as target equity incentive data, to the first terminal device, and enabling the first terminal device to update the initial equity incentive data based on the target equity incentive data.

In a second aspect, the present disclosure provides an electronic device including a processor and a memory. The memory is configured to store executable instructions of the processor. The processor is configured to execute any method in the first aspect or the possible embodiments of the first aspect by executing the executable instruction.

In a third aspect, the present disclosure provides a computer storage medium, a computer program is stored on the computer storage medium, and the computer program is executed by a processor to implement either the first aspect or any of the possible embodiments of the first aspect.

### BRIEF DESCRIPTION OF THE DRAWINGS

To more clearly illustrate the technical solutions in some embodiments of the present disclosure or the related art, the following will briefly introduce the drawings that need to be used in the description of some embodiments or the related art. Obviously, the drawings in the following description are some embodiments of the present disclosure, those skilled in the art may further obtain other drawings without any creative work according to these drawings.

FIG. 1 is a flowchart of a processing method for equity incentive data according to some embodiments of the present disclosure.

FIG. 2 is a schematic flowchart of a calculation method stock for consolidation according to some embodiments of the present disclosure.

FIG. 3 is a schematic structural view of a processing apparatus for equity incentive data according to some embodiments of the present disclosure.

FIG. 4 is a schematic structural view of an electronic device according to some embodiments of the present disclosure.

### DETAILED DESCRIPTION

The embodiments of the present disclosure are described in detail below, and examples of the embodiments are illustrated in the drawings. The embodiments described below with reference to the drawings are exemplary and are intended to explain the present disclosure, but should not be construed as limiting the present disclosure.

The terms “first” and “second” in the description, claims, and drawings of the embodiments of the present disclosure are used to distinguish similar objects, and are not necessarily used to describe a specific sequence or order. It should be understood that the data used in this way may be interchanged under appropriate circumstances, so that the embodiments of the present disclosure described herein may be implemented in an order other than those illustrated or described herein. In addition, the terms “include” and “have” and any variations thereof are intended to cover non-exclusive inclusion. For example, processes, methods, systems, products, or device that includes a series of steps or units is not necessarily limited to those clearly listed steps or units, but may include other steps or units that are not clearly listed or are inherent to these processes, methods, products, or devices.

The processing method for equity incentive data provided by the present disclosure may be run on a terminal device or a server. The terminal device may be a local terminal device. The server may be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms.

ESOP (Employee Stock Ownership Plan), also known as an equity incentive, refers to a mechanism that allows employees to hold stocks and participate in a company's profit-sharing mechanism and decision-making process, thereby attracting, retaining, and motivating the employees of the company. Stock consolidation refers to an event of consolidating several old stocks into one new stock and increasing the par value per stock of the new stock accordingly. After a stock consolidation conducted by a listed company, in order to ensure that the rights and interests of company employees are not affected, it is usually necessary to correspondingly adjust the equity incentive data held by employees. However, in the related art, adjusting the equity incentive data held by employees requires a relatively complex adjustment and update process, resulting in low adjustment efficiency of the equity incentive data and low reliability of the adjusted equity incentive data.

The technical solutions of the present disclosure and how the technical solutions of the present disclosure solve the above technical problems are described in detail below with specific embodiments. The following specific embodiments may be combined with each other, and for the same or similar concepts or processes, some embodiments may not be repeated. The embodiments of the present disclosure are described below with reference to the drawings.

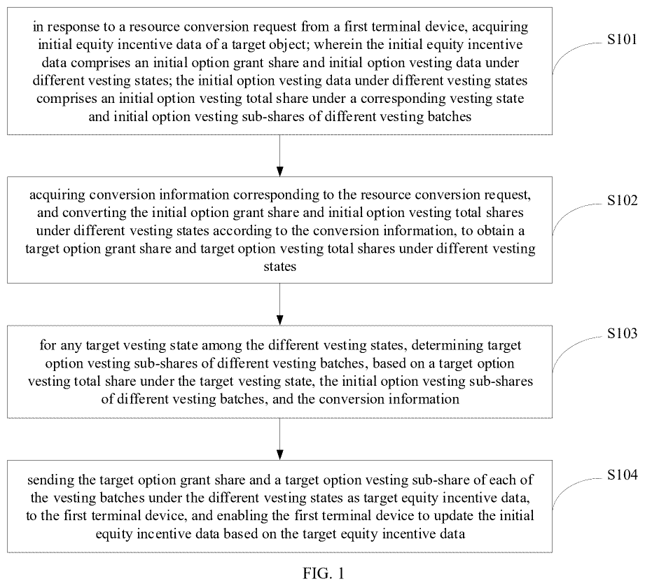

FIG. 1 is a flowchart of a processing method for equity incentive data according to some embodiments of the present disclosure. The processing method may be applied to various devices with data processing functions. Taking the processing method being applied to a business server as an example, the solution at least includes the following S101-S104.
S101: In response to a resource conversion request from a first terminal device, acquiring initial equity incentive data of a target object.

The resource conversion request may be configured to indicate request information for performing amount conversion on the initial equity incentive data of the target object. In some embodiments, the first terminal device may be a terminal device that sends the resource conversion request, and may be configured to display the initial equity incentive data of the target object.

In some embodiments of the present disclosure, the target object may be employees in enterprises.

In some embodiments, the initial equity incentive data includes an initial option grant share and initial option vesting data under different vesting states.

In some embodiments, the initial option grant share refers to the share amount of incentive equity granted to the target object before the enterprise conducts stock consolidation. The initial option vesting data under different vesting states includes a share data of incentive equity under different vesting states among the incentive equity granted to the target object. A sum of the share data of the incentive equity under the different vesting states may be the same as the initial option grant share.

It can be understood that the equity incentive data may include a RSU (Restricted Stock Unit) incentive equity and/or an OPTION incentive equity. The process of transferring the equity incentive data from an account corresponding to an enterprise object to an account corresponding to the target object generally may include two stages. One may be a grant stage where the enterprise object grants a certain amount of equity data to the target object on a grant date. The other may be a vesting stage where the target object exchanges the equity data on a vesting date (or during a vesting period). Therefore, the initial option grant share corresponding to the equity incentive data may at least include an option vesting data corresponding to a vested state and an option vesting data corresponding to a to-be-vested state.

In some embodiments, the initial option vesting data under different vesting states may include an initial option vesting total share under a corresponding vesting state and initial option vesting sub-shares of different vesting batches.

In some embodiments, the different vesting batches refer to vesting the initial option vesting total share in preset batches. For example, for 10,000 shares of employee A, the vesting may be divided into two periods. That is, a first period vesting of 500 shares and a second period vesting of 500 shares.

In some embodiments, the vesting states may include a vested state, a to-be-vested state, and a to-be-vested cancelling state. The vested state means that the incentive equity has been vested (in the name of) the target object. That is, the target object may have obtained ownership or exercise rights of the incentive equity granted by the enterprise. The to-be-vested state means that the incentive equity has been granted to the target object but has not yet been vested in the name of the target object. That is, the incentive equity has been granted to the target object, but the target object has not yet obtained ownership or exercise rights of the incentive equity. The to-be-vested cancelling state means canceling the incentive equity that has not yet been vested in the name of the target object.

In some embodiments, taking the first terminal device as a management terminal device of a company A and the business server as an ESOP business terminal as an example, in a case where the company A needs to perform stock consolidation data source, it may send a resource conversion request to the business server. The business server, in response to receiving the resource conversion request from the first terminal device, may acquire the initial equity incentive data of the target object. The initial equity incentive data of the target object may include the initial option grant share of incentive equity granted to any employee object under the company A and the initial option vesting data of the incentive equity under different vesting states.

For example, in a case where an employee B of the company A is granted 1000 shares, the 1000 shares are the initial option grant share, the initial option vesting data under the vested state may be 500 shares, the initial option vesting data under the to-be-vested state may be 500 shares, and the initial option vesting data under the to-be-vested cancelling state may be 0 shares.
S102: Acquiring conversion information corresponding to the resource conversion request, and converting the initial option grant share and initial option vesting total shares under different vesting states according to the conversion information, to obtain a target option grant share and target option vesting total shares under different vesting states

The conversion information may be configured to indicate a conversion ratio for performing amount conversion on the initial equity incentive data of the target object.

In some embodiments, the target option vesting total share under different vesting states may refer to a total share of option vesting shares of all batches under any vesting state.

In some embodiments, the conversion information may refer to a stock consolidation ratio. For example, 10/1 may indicate consolidating ten shares of options into one share of option. The conversion information may be set according to actual situations.

For example, in a case where the conversion information is a stock consolidation ratio of 10/1 and the initial option grant share is 1000, according to the stock consolidation ratio of 10/1, the initial option grant share of 1000 shares of incentive equity may be converted to a target option grant share of 100 shares.

For example, in a case where the conversion information is a stock consolidation ratio of 10/1 and an initial option vesting total share under a certain vesting state is 100, according to the stock consolidation ratio of 10/1, the initial option vesting total share of 100 under the certain vesting state may be converted to a target option vesting total share of 10 under the certain vesting state.

In some embodiments, after acquiring the resource conversion request, in response to the resource conversion request, n resource operation interfaces may be acquired, where the n may be greater than or equal to 2, calling a resource operation program corresponding to the resource operation interfaces, and performing a resource conversion operation on the initial option grant share and the initial option vesting data corresponding to each of the vesting states to obtain the target option grant share and the target option vesting total shares under the different vesting states.

In some embodiments, the converting the initial option grant share and initial option vesting total shares under different vesting states according to the conversion information, to obtain a target option grant share and target option vesting total shares under different vesting states, may include steps S11-S12.
S11: Converting the initial option grant share, an initial vested option total share under the vested state, and an initial to-be-vested cancelling option total share under the to-be-vested cancelling state according to the conversion information, to obtain the target option grant share, a target vested option total share under the vested state, and a target to-be-vested cancelling total option share under the to-be-vested cancelling state.

In some embodiments, taking the incentive equity granted to the target object being vested in two periods as an example, in a case where the initial option grant share is 100, the initial vested option total share under the vested state is 60, the initial to-be-vested cancelling option total share under the to-be-vested cancelling state is 40, and the conversion information is a stock consolidation ratio of three-for-one, thus the initial option grant share of 100 may be converted to a target option grant share of 34, the initial vested option total share of 60 under the vested state may be converted to a target vested option total share of 20 under the vested state, and the initial to-be-vested cancelling option total share of 40 under the to-be-vested cancelling state may be converted to a target to-be-vested cancelling total option share of 13 under the to-be-vested cancelling state.

In some embodiments, the initial option grant share may be a sum of the initial vested option total share under the vested state and the initial to-be-vested cancelling option total share under the to-be-vested cancelling state.

In some embodiments, in an actual conversion process, different types of incentive equity data correspond to different conversion methods. Therefore, it is necessary to determine the type of the incentive equity data when the stock consolidation is performed. For example, for the RSU incentive equity, after the vesting option is granted, the stock may be directly deposited to the user's account. For the OPTION incentive equity, after the vesting option is granted, the user needs to exercise the option during a window period, and then the stock may be deposited to the user's account.

For the RSU incentive equity, the target option grant share may be the initial option grant share divided by the stock consolidation ratio and a result is rounded up. For example, in a case where the initial option grant share is 100 and the stock consolidation ratio is 3/1, the target option grant share may be 100/3, and the result rounded up may be 34.

The target vested option total share under the vested state may be the initial vested option total share under the vested state divided by the stock consolidation ratio, and a result may be rounded up. For example, in a case where the initial vested option total share under the vested state is 100 and the stock consolidation ratio is 3/1, the target vested option total share under the vested state may be 100/3, and the result rounded up may be 34.

In some embodiments, the target to-be-vested cancelling total option share under the to-be-vested cancelling state may be the initial to-be-vested cancelling option total share under the to-be-vested cancelling state divided by the stock consolidation ratio, and a result may be rounded down. For example, in a case where the initial to-be-vested cancelling option total share under the to-be-vested cancelling state is 100 and the stock consolidation ratio is 3/1, the target to-be-vested cancelling total option share under the to-be-vested cancelling state may be 100/3, and the result rounded down may be 33.

For the OPTION incentive equity, the target option grant share may be the initial option grant share divided by the stock consolidation ratio, and the result may be rounded up. For example, in a case where the initial option grant share is 100 and the stock consolidation ratio is 3/1, the target option grant share may be 100/3, and the result rounded up may be 34.

The target vested option total share under the vested state may be the initial vested option total share under the vested state divided by the stock consolidation ratio, and the result may be rounded down. For example, in a case where the initial vested option total share under the vested state is 100 and the stock consolidation ratio is 3/1, the target vested option total share under the vested state may be 100/3, and the result rounded down may be 33.

The target to-be-vested cancelling total option share under the to-be-vested cancelling state may be the initial to-be-vested cancelling option total share under the to-be-vested cancelling state divided by the stock consolidation ratio, and the result may be rounded down. For example, in a case where the initial to-be-vested cancelling option total share under the to-be-vested cancelling state is 100 and the stock consolidation ratio is 3/1, the target to-be-vested cancelling total option share under the to-be-vested cancelling state may be 100/3, and the result rounded down may be 33.
S12: Obtaining a target to-be-vested state option total share under the to-be-vested state according to the target option grant share, the target vested option total share under the vested state, and the target to-be-vested cancelling total option share under the to-be-vested cancelling state.

In some embodiments, the target to-be-vested state option total share under the to-be-vested state may be the target option grant share minus the target vested option total share under the vested state and the target to-be-vested cancelling total option share under the to-be-vested cancelling state.

For example, in a case where the target option grant share is 100, the target vested option total share under the vested state is 30, and the target to-be-vested cancelling total option share under the to-be-vested cancelling state is 20, the target to-be-vested state option total share under the to-be-vested state may be 50. By adopting this division manner, the adjustment efficiency of the incentive equity may be improved.

In some embodiments, the resource operation program corresponding to the resource operation interface may include a first operation program and a second operation program. After acquiring the resource operation interface, the initial option grant share and the initial option vesting data corresponding to each of the vesting states may be configured as program execution parameters and passed into the resource operation interface, then the resource operation interface may call the first operation program or the second operation program to perform the resource conversion operation according to the passed program execution parameters. After acquiring the resource operation interface, the initial option grant share and the initial option vesting data corresponding to each of the vesting states may be configured as program execution parameters and passed into the resource operation interface, and the resource operation interface may perform a lock competition operation. The lock competition operation may identify a parameter type of the passed program execution parameters. In a case where the passed program parameters are the initial option grant share, the initial vested option total share under the vested state, or the initial to-be-vested cancelling option total share under the to-be-vested cancelling state, a result of the lock competition operation result may be determined to be 0. In this case, the first operation program may be called to perform the resource conversion operation on the passed program execution parameters to obtain an operation result of the resource conversion operation (i.e., the target option grant share, the target vested option total share under the vested state, and the target to-be-vested cancelling total option share under the to-be-vested cancelling state), and the operation result of the resource conversion operation may be passed into other resource operation interfaces with the result of the lock competition operation of 1. In a case where the passed program parameter is the initial to-be-vested state option total share under the to-be-vested state, the result of the lock competition operation may be determined to be 1. In this case, the resource operation interface may be locked, and after receiving corresponding operation results passed from other resource operation interfaces, the second operation program may be called to perform the resource conversion operation on the passed program execution parameters. By performing locking processing on some resource operation interfaces and operating other resource operation interfaces in parallel, the efficiency and accuracy of the resource conversion operations may be improved.

In some embodiments, the resource operation interface performing the lock competition operation may be performed by determining similarity through string matching. In some embodiment, the lock competition operation result may be determined based on a similarity between a parameter type label carried by the program execution parameters and an application type label corresponding to the second operation program, specifically as follows.

$$Sim ( Lab\_input , Lab\_app ) = α \cdot \frac{\vert Lab\_input - Lab\_app \vert}{log 2 \vert Lab\_input + Lab\_app \vert}$$

Among them, Lab_input represents a string corresponding to the parameter type label carried by the program execution parameters, Lab_app represents a string corresponding to the application type label corresponding to the second operation program, |∩| represents a vector sum between characters in the string, that is, a modulus of the string, and α represents a preset label factor. In this embodiment, by calculating the similarity between the parameter type label carried by the program execution parameters and the application type label corresponding to the second operation program, the acquisition efficiency of the lock competition operation result may be improved. In some embodiments, in a case where the similarity is equal to 1, the lock competition operation result may be determined to be 1. In a case where the similarity is not equal to 1, the lock competition operation result may be determined to be 0.

In some embodiments, the initial vested option total share under the vested state may include an initial exercised option share, an initial to-be-exercised option share, and an initial vested cancelled option share.

In some embodiments, the initial vested option total share under the vested state may be a sum of the initial exercised option share, the initial to-be-exercised option share, and the initial vested cancelled option share.

In some embodiments, the processing method may further include steps S21-S22.
S21: Converting the initial exercised option share and the initial to-be-exercised option share to obtain a target exercised option share and a target to-be-exercised option share based on the conversion information.
S22: Obtaining a target vested cancelled option share corresponding to the initial vested cancelled option share according to the target vested option total share, the target exercised option share, and the target to-be-exercised option share.

Taking the OPTION incentive equity as an example, the process of transferring the incentive equity from the account of the enterprise object to the account of the target object may also include an exercise stage in addition to the grant stage and the vesting stage. That is, after the incentive equity is vested in the target object, and the target object selects a certain date as an exercise date to exercise the incentive equity, and then the corresponding incentive equity may be transferred to the account of the target object. The exercised option share may refer to the share amount of the incentive equity that has been exercised by the target object among the incentive equity corresponding to the total vested option share under the vested state. The to-be-exercised option share may refer to the share amount of the incentive equity that has not been exercised by the target object among the incentive equity corresponding to the total vested option share under the vested state. The vested cancelled option share may refer to the share amount of the incentive equity that has been recalled or voided by the enterprise among the incentive equity corresponding to the total vested option share under the vested state.

In a case where the incentive equity is the OPTION incentive equity, based on the conversion information, the initial exercised option share may be converted to a corresponding target exercised option share, and the initial to-be-exercised option share may be converted to a target to-be-exercised option share, then a sum of the target exercised option share and the target to-be-exercised option share may be calculated, and according to a difference between the target vested option total share and the sum of the target exercised option share and the target to-be-exercised option share, the target vested cancelled option share may be determined.

For example, in a case where the initial vested cancelled option share is 0, and the target vested option total share is not equal to a sum of the target exercised option share and the target to-be-exercised option share, adjusting the target vested cancelled option share, enabling the target vested option total share to be equal to the sum of the target exercised option share and the target to-be-exercised option share.

Taking the initial vested option total share under the vested state as 100, the initial exercised option share as 40, the initial to-be-exercised option share as 60, and the stock consolidation ratio (i.e., conversion information) as 3/1 as an example, the target exercised option share may be determined to be 13, the target to-be-exercised option share may be determined to be 20, and the target vested option total share may be determined to be 34. Since the target vested option total share is not equal to the sum of the target exercised option share and the target to-be-exercised option share, that is, 13 plus 20 is not equal to 34, the difference between the target vested option total share and the target exercised option share and the target to-be-exercised option share may be taken as the target vested cancelled option share. That is, 34−13−20=1. The remainder 1 may be taken as the target vested cancelled option share to ensure that the corresponding target to-be-exercised option share of the target object is maximized. By adopting the priority principle of exercise compensation, the reliability of the adjustment of the equity incentive data may be greatly improved.

Further, in a case where the target vested cancelled option share is not 0, it may be determined whether the target to-be-vested cancelling total option share is 0. In a case where the target to-be-vested cancelling total option share is 0, the difference between the target vested option total share and the target exercised option share and the target to-be-exercised option share may be taken as the target to-be-vested cancelling total option share. In a case where the target to-be-vested cancelling total option share is not 0, it may be determined whether the target to-be-vested state option total share is 0. In a case where the target to-be-vested cancelling total option share is 0, the difference between the target vested option total share and the target exercised option share and the target to-be-exercised option share may be taken as the target to-be-vested state option total share.

In some embodiments, the processing method may further include: obtaining an initial to-be-vested state option quantity corresponding to the to-be-vested state from the initial option vesting total shares under the different vesting states. In a case where the initial to-be-vested state option quantity is 0, and the target option grant share is not equal to a sum of the target vested option total share under the vested state and the target to-be-vested cancelling total option share under the to-be-vested cancelling state, then adjusting the target to-be-vested cancelling total option share under the to-be-vested cancelling state to obtain an adjusted to-be-vested cancelling option quantity, enabling the target option grant share to be equal to the sum of the target vested option total share under the vested state and the target to-be-vested cancelling total option share under the to-be-vested cancelling state.

For example, the initial option grant share is 100, the initial vested option total share under the vested state is 60, the initial to-be-vested cancelling option total share under the to-be-vested cancelling state is 40, the initial to-be-vested state option quantity is 0, and the conversion information is a stock consolidation ratio of three-for-one, so the initial option grant share of 100 may be converted to a target option grant share of 34, the initial vested option total share of 60 under the vested state may be converted to a target vested option total share of 20 under the vested state, and the initial to-be-vested cancelling option total share of 40 under the to-be-vested cancelling state may be converted to a target to-be-vested cancelling total option share of 13 under the to-be-vested cancelling state. Further, since the target option grant share is not equal to the sum of the target vested option total share under the vested state and the target to-be-vested cancelling total option share under the to-be-vested cancelling state, the initial to-be-vested cancelling option total share of 40 under the to-be-vested cancelling state may be subtracted from the target vested option total share of 20 under the vested state and the target to-be-vested cancelling total option share of 13 under the to-be-vested cancelling state to obtain a difference as the adjusted to-be-vested cancelling option quantity.
S103: For any target vesting state among the different vesting states, determining target option vesting sub-shares of different vesting batches based on a target option vesting total share under the target vesting state, the initial option vesting sub-shares of different vesting batches, and the conversion information.

After obtaining the target option vesting total shares under the different vesting states, for any vesting state, i.e., the target vesting state, according to the target vesting total share under the target vesting state and the conversion information, the initial option vesting sub-shares of different vesting batches may be converted to target option vesting sub-shares in sequence according to an order of the vesting batches under the vesting state.

For example, an enterprise grants the target object with the incentive equity of the initial option grant share of 1000 shares, and the vesting is performed in 10 periods, with 100 shares vested in each period. Among the periods, periods 1 to 6 may have been vested. That is, the shares of the incentive equity corresponding to periods 1 to 6 may be initial option vesting sub-shares under the vested state. Periods 7 to 10 may have not been vested. That is, the shares of the incentive equity corresponding to periods 7 to 10 are initial option vesting sub-shares under the to-be-vested state. According to the initial option vesting sub-shares of each period under the different vesting states and the conversion information, target option vesting sub-share of each of the vesting batches under the vesting state may be determined. One period may be one vesting batch.

In some embodiments, determining target option vesting sub-shares of different vesting batches based on a target option vesting total share under the target vesting state, initial option vesting sub-shares of different vesting batches, and the conversion information may include S31-S32.
S31: For each initial option vesting sub-share of the previous (n−1) vesting batches, in a case where a quantity of vesting batches under the target vesting state is n, and n is greater than 1, converting the initial option vesting sub-shares, based on the conversion information to obtain target option vesting sub-shares of the previous (n−1) vesting batches.

In some embodiments, the target option vesting sub-shares of the previous (n−1) vesting batches may be the initial option vesting sub-shares of the previous (n−1) vesting batches divided by the stock consolidation ratio (rounded down).
S32: For an initial option vesting sub-share of an nth vesting batch, determining a target option vesting sub-share of the nth vesting batch, based on the target option vesting total share under the target vesting state and the target option vesting sub-shares of the previous (n−1) vesting batches.

In some embodiments, the target option vesting sub-share of the nth vesting batch may be a difference between the target option vesting total share under the target vesting state and the target option vesting sub-shares of the previous (n−1) vesting batches.
S104: Sending the target option grant share and the target option vesting sub-share of each of the vesting batches under the different vesting states as target equity incentive data to the first terminal device, and enabling the first terminal device to update the initial equity incentive data based on the target equity incentive data.

In some embodiments, the processing method may further include: determining whether the initial equity incentive data meets a preset condition. If yes, determining to the conversion information corresponding to the resource conversion request and converting the initial option grant share and the initial option vesting total shares under the different vesting states based on the conversion information.

In a case where the initial equity incentive data is in an effective state, and there is currently no pending review task, and the options that have been determined to be vested have been allocated to corresponding employees, then the initial equity incentive data may be considered to meet the preset conditions.

In an actual operation process, in a case where there is equity incentive data to be effective in an ESOP system, the equity incentive data to be effective need to be processed first by administrators.

In an actual operation process, there may be no pending review task (vesting review, tax calculation review) in the ESOP system, ensuring that there is no old equity data that has not been consolidated in the system, thus ensuring consistency between consolidated data and review data.

In an actual operation process, there may be no stocks that have been confirmed to be vested but have not been allocated in the ESOP system, ensuring data consistency in the stock vesting and option exercise processes. Otherwise, the quantity and price changes caused by consolidation may cause changes in the value of stock vesting and option exercise.

In some embodiments, a grant price of a stock may be a product of an initial grant price and a stock consolidation ratio.

In some embodiments, a closing price on a registration date of a stock after vesting may be a product of a closing price on the registration date and the stock consolidation ratio.

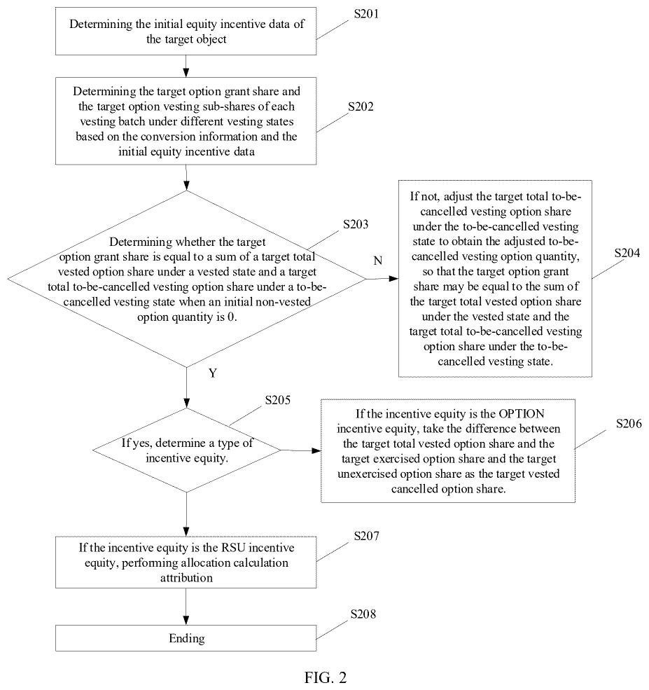

To better understand the solution, some embodiments of calculations of the stock consolidation are listed below, as shown in FIG. 2, and specific steps include S201-208.
S201: Determining the initial equity incentive data of the target object.

In some embodiments, the initial equity incentive data may include the initial option grant share and the initial option vesting data under different vesting states.
S202: Determining the target option grant share and the target option vesting sub-shares of different vesting batches under different vesting states based on the conversion information and the initial equity incentive data.

In some embodiments, the embodiments of S102 and S103 may be referred.
S203: Determining whether the target option grant share is equal to a sum of a target vested option total share under a vested state and a target to-be-vested cancelling total option share under a to-be-vested cancelling state in a case where the initial to-be-vested state option quantity is 0.
S204: If not, adjust the target to-be-vested cancelling total option share under the to-be-vested cancelling state to obtain the adjusted to-be-vested cancelling option quantity, so that the target option grant share may be equal to the sum of the target vested option total share under the vested state and the target to-be-vested cancelling total option share under the to-be-vested cancelling state.

In some embodiments, the embodiments of S22 may be referred.
S205: If yes, determine a type of incentive equity. In a case where the incentive equity is the OPTION incentive equity, proceed to S206. In a case where the incentive equity is the RSU incentive equity, proceed to S207.

In some embodiments, the incentive equity may include the RSU (Restricted Stock Unit) incentive equity and the OPTION incentive equity.
S206: Converting the initial exercised option share and the initial to-be-exercised option share to obtain the target exercised option share and the target to-be-exercised option share based on the conversion information, and obtaining the target vested cancelled option share corresponding to the initial vested cancelled option share according to the target vested option total share, the target exercised option share, and the target to-be-exercised option share, then proceed to S207.
S207: Performing allocation calculation attribution: for any target vesting state among the different vesting states, determining target option vesting sub-shares of different vesting batches, based on a target option vesting total share under the target vesting state, the initial option vesting sub-shares of different vesting batches, and the conversion information.
S208: Ending.

In some embodiments, in actual operation, according to the stock consolidation ratio, a grant price of a stock and a closing price on a registration date may be increased to ensure that a grant value remains unchanged, thereby ensuring that the interests of employees may not be damaged.

The technical solution provided by the present disclosure, in response to a resource conversion request from a first terminal device, acquiring initial equity incentive data of a target object. The initial equity incentive data includes an initial option grant share and initial option vesting data under different vesting states. The initial option vesting data under different vesting states includes an initial option vesting total share under a corresponding vesting state and initial option vesting sub-shares of different vesting batches. Acquiring conversion information corresponding to the resource conversion request, and converting the initial option grant share and initial option vesting total shares under different vesting states according to the conversion information, to obtain a target option grant share and target option vesting total shares under different vesting states. For any target vesting state among the different vesting states, determining target option vesting sub-shares of different vesting batches based on the target option vesting total share under the target vesting state, the initial option vesting sub-shares of different vesting batches, and the conversion information. Sending the target option grant share and the target option vesting sub-share of each of the vesting batches under the different vesting states as target equity incentive data to the first terminal device, and enabling the first terminal device to update the initial equity incentive data based on the target equity incentive data. The technical solutions provided by some embodiments of the present disclosure may, in response to receiving the resource conversion request from the first terminal device, directly perform corresponding adjustment on the equity incentive data held by employees, without performing a complex adjustment and update process, thereby improving the adjustment efficiency of the equity incentive data and making the adjusted equity incentive data more reliable.

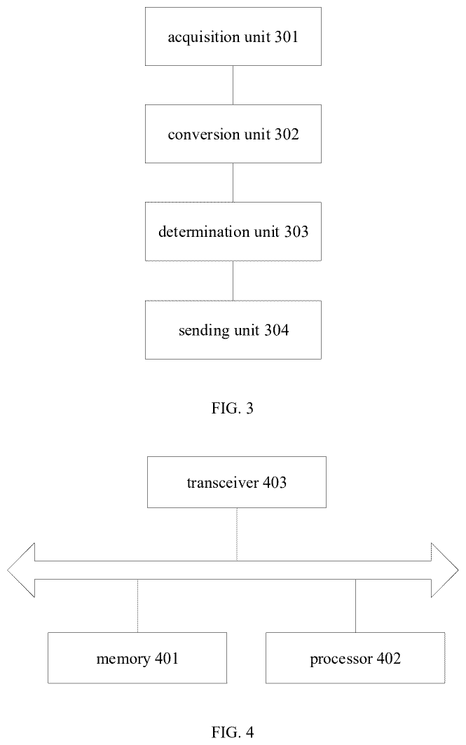

FIG. 3 is a schematic structural view of a processing apparatus for equity incentive data according to some embodiments of the present disclosure.

The apparatus may be applied to a business server, and may include an acquisition unit 301, a conversion unit 302, a determination unit 303, and a sending unit 304.

The acquisition unit 301 is configured to acquire initial equity incentive data of a target object in response to a resource conversion request from a first terminal device. The initial equity incentive data includes an initial option grant share and initial option vesting data under different vesting states. The initial option vesting data under different vesting states includes an initial option vesting total share under a corresponding vesting state and initial option vesting sub-shares of different vesting batches.

The conversion unit 302 is configured to acquire conversion information corresponding to the resource conversion request, and converting the initial option grant share and initial option vesting total shares under different vesting states, to obtain a target option grant share and a target option vesting total share under different vesting states, based on acquired conversion information.

The determination unit 303 is configured to determine target option vesting sub-shares of different vesting batches for any target vesting state among the different vesting states, based on the target option vesting total share under the target vesting state, the initial option vesting sub-shares of different vesting batches, and the conversion information.

The sending unit 304 is configured to send the target option grant share and the target option vesting sub-share of each of the vesting batches under the different vesting states as target equity incentive data to the first terminal device, and enabling the first terminal device to update the initial equity incentive data based on the target equity incentive data.

In some embodiments, the vesting states may include a vested state, a to-be-vested state, and a to-be-vested cancelling state.

The apparatus is further configured to acquire conversion information corresponding to the resource conversion request, and converting the initial option grant share and initial option vesting total shares under different vesting states, to obtain a target option grant share and a target option vesting total share under different vesting states, based on acquired conversion information, and is specifically configured to execute methods as follow.

Converting the initial option grant share, an initial vested option total share under the vested state, and an initial to-be-vested cancelling option total share under the to-be-vested cancelling state according to the conversion information, to obtain the target option grant share, a target vested option total share under the vested state, and a target to-be-vested cancelling total option share under the to-be-vested cancelling state.

Obtaining a target to-be-vested state option total share under the to-be-vested state according to the target option grant share, the target vested option total share under the vested state, and the target to-be-vested cancelling total option share under the to-be-vested cancelling state.

In some embodiments, the initial vested option total share under the vested state may include an initial exercised option share, an initial to-be-exercised option share, and an initial vested cancelled option share.

The apparatus is further configured to execute methods as follow.

Converting the initial exercised option share and the initial to-be-exercised option share to obtain a target exercised option share and a target to-be-exercised option share based on the conversion information.

Obtaining a target vested cancelled option share corresponding to the initial vested cancelled option share according to the target vested option total share, the target exercised option share, and the target to-be-exercised option share.

In some embodiments, the apparatus is further configured to determine target option vesting sub-shares of different vesting batches based on the target option vesting total share under the target vesting state, the initial option vesting sub-shares of different vesting batches, and is specifically configured to perform operation as follow.

For each initial option vesting sub-share of the previous (n−1) vesting batches, when a quantity of vesting batches under the target vesting state is n, and n is greater than 1, converting the initial option vesting sub-shares, based on the conversion information to obtain target option vesting sub-shares of the previous (n−1) vesting batches.

For an initial option vesting sub-share of an nth vesting batch, determining a target option vesting sub-share of the nth vesting batch, based on the target option vesting total share under the target vesting state and the target option vesting sub-shares of the previous (n−1) vesting batches.

In some embodiments, the apparatus is further configured to execute methods as follow.

Obtaining an initial to-be-vested state option quantity corresponding to the to-be-vested state from the initial option vesting total shares under the different vesting states.

In a case where the initial to-be-vested state option quantity is 0, and the target option grant share is not equal to a sum of the target vested option total share under the vested state and the target to-be-vested cancelling total option share under the to-be-vested cancelling state, adjusting the target to-be-vested cancelling total option share under the to-be-vested cancelling state to obtain an adjusted to-be-vested cancelling option quantity, and enabling the target option grant share to be equal to the sum of the target vested option total share under the vested state and the target to-be-vested cancelling total option share under the to-be-vested cancelling state.

In some embodiments, the apparatus is further configured to execute methods as follow.

In a case where the initial vested cancelled option share is 0, and the target vested option total share is not equal to a sum of the target exercised option share and the target to-be-exercised option share, adjusting the target vested cancelled option share, enabling the target vested option total share to be equal to the sum of the target exercised option share and the target to-be-exercised option share.

In some embodiments, the apparatus is further configured to execute methods as follow.

Determining whether the initial equity incentive data meets a preset condition. If yes, determining to the conversion information corresponding to the resource conversion request and converting the initial option grant share and the initial option vesting total shares under the different vesting states based on the conversion information.

The initial equity incentive data is considered to meet the preset condition in a case where the initial equity incentive data is in an effective state, and there is currently no pending review task, and options that have been determined to be vested have been allocated to corresponding employees.

The technical solution provided by the present disclosure, in response to a resource conversion request from a first terminal device, acquiring initial equity incentive data of a target object. The initial equity incentive data includes an initial option grant share and initial option vesting data under different vesting states. The initial option vesting data under different vesting states includes an initial option vesting total share under a corresponding vesting state and initial option vesting sub-shares of different vesting batches. Acquiring conversion information corresponding to the resource conversion request, and converting the initial option grant share and initial option vesting total shares under different vesting states according to the conversion information, to obtain a target option grant share and target option vesting total shares under different vesting states. For any target vesting state among the different vesting states, determining target option vesting sub-shares of different vesting batches, based on the target option vesting total share under the target vesting state, the initial option vesting sub-shares of different vesting batches, and the conversion information. Sending the target option grant share and a target option vesting sub-share of each of the vesting batches under the different vesting states as target equity incentive data, to the first terminal device, and enabling the first terminal device to update the initial equity incentive data based on the target equity incentive data. The technical solutions provided by some embodiments of the present disclosure may, in response to receiving the resource conversion request from the first terminal device, directly perform corresponding adjustment on the equity incentive data held by employees, without performing a complex adjustment and update process, thereby improving the adjustment efficiency of the equity incentive data and making the adjusted equity incentive data more reliable.

It should be understood that the embodiments of the apparatus and the embodiments the processing method may correspond to each other, and similar descriptions may refer to the processing method embodiments. To avoid repetition, details are not described herein again. Specifically, the apparatus may execute the above method embodiments, and the foregoing and other operations and/or functions of the various modules in the apparatus are respectively for the corresponding processes in the various methods in the above method embodiments, and will not be repeated here for brevity.

The embodiments of the apparatus of the present disclosure has been described above from the perspective of functional modules in combination with the drawings. It should be understood that the functional modules may be implemented in hardware, may be implemented by instructions in software form, and may also be implemented by a combination of hardware and software modules. Specifically, each step in the embodiments of the processing method of the present disclosure may be completed by an integrated logic circuit of hardware in a processor and/or instructions in software form. The steps of the processing method disclosed in the embodiments of the present disclosure may be directly embodied as being executed and completed by a hardware decoding processor, or executed and completed by a combination of hardware and software modules in the decoding processor. Optionally, the software modules may be disposed in mature storage media in the field such as random access memory, flash memory, read-only memory, programmable read-only memory, electrically erasable programmable memory, registers, etc. The storage medium may be disposed in a memory, and the processor reads information in the memory and completes the steps in the above method embodiments in combination with its hardware.

FIG. 4 is a schematic structural view of an electronic device according to some embodiments of the present disclosure. The electronic device may include a memory 401 and a processor 402.

The memory 401 is configured to store a computer program and transmit the program code to the processor 402. That is, the processor 402 may call and run the computer program from the memory 401 to implement the processing method in the embodiments of the present disclosure.

For example, the processor 402 may be configured to execute the above embodiments of the methods according to instructions in the computer program.

In some embodiments of the present disclosure, the processor 402 may include, but is not limited to a general-purpose processor, a digital signal processor (DSP), an application specific integrated circuit (ASIC), a field programmable gate array (FPGA) or other programmable logic device, a discrete gate or transistor logic device, a discrete hardware component, etc.

In some embodiments of the present disclosure, the memory 401 may include, but is not limited to a volatile memory and/or a non-volatile memory. The non-volatile memory may be read-only memory (ROM), programmable read-only memory (PROM), erasable programmable read-only memory (EPROM), electrically erasable programmable read-only memory (EEPROM), or flash memory. The volatile memory may be random access memory (RAM), which is used as an external cache. By way of illustrative but not restrictive description, many forms of RAM may be available, such as static random access memory (SRAM), dynamic random access memory (DRAM), synchronous dynamic random access memory (SDRAM), double data rate synchronous dynamic random access memory (DDR SDRAM), enhanced synchronous dynamic random access memory (ESDRAM), synch link dynamic random access memory (SLDRAM), and direct rambus random access memory (DR RAM).

In some embodiments of the present disclosure, the computer program may be divided into one or more modules, and the one or more modules may be stored in the memory 401 and executed by the processor 402 to complete the processing method provided by the present disclosure. The one or more modules may be a series of computer program instruction segments capable of completing a specific function, and the instruction segments are used to describe an execution process of the computer program in the electronic device.

As shown in FIG. 4, the electronic device may further include a transceiver 403, and the transceiver 403 may be connected to the processor 402 or the memory 401.

The processor 402 may control the transceiver 403 to communicate with other devices. In some embodiments, the transceiver 403 may send information or data to other devices, or receive information or data sent by other devices. The transceiver 403 may include a transmitter and a receiver. The transceiver 403 may further include one or more antennas.

It should be understood that the various components in the electronic device are connected through a bus system. The bus system may include not only a data bus but also a power bus, a control bus, and a status signal bus.

The present disclosure also provides a computer storage medium. A computer program may be stored on the computer storage medium. When the computer program is executed by a computer, the computer may perform the above embodiments of the processing method. In other words, the embodiments of the present disclosure also provide a computer program product including instruction. When the instruction is executed by a computer, the computer may perform the above embodiments of the processing method.

When implemented in software, it may be implemented entirely or partially in the form of a computer program product. The computer program product may include one or more computer instructions. When the computer program instructions are loaded and executed on a computer, the processes or functions according to the embodiments of the present disclosure may be generated entirely or partially. The computer may be a general-purpose computer, a special-purpose computer, a computer network, or other programmable devices. The computer instructions may be stored in a computer-readable storage medium, or transmitted from one computer-readable storage medium to another computer-readable storage medium. For example, the computer instructions may be transmitted from a website, a computer, a server, or a data center to another website, another computer, another server, or another data center by wired means (e.g., coaxial cable, optical fiber, digital subscriber line (DSL)) or wireless means (e.g., infrared, wireless, microwave, etc.). The computer-readable storage medium may be any available medium that can be accessed by a computer or a data storage device such as a server or a data center that integrates one or more available media integrations. The available medium may be a magnetic medium (e.g., floppy disk, hard disk, magnetic tape), an optical medium (e.g., digital video disc (DVD)), or a semiconductor medium (e.g., solid state disk (SSD)), etc.

Those skilled in the art may appreciate that the modules and algorithm steps of the examples described in combination with the embodiments disclosed herein can be implemented in electronic hardware, or a combination of computer software and electronic hardware. Whether these functions are performed in hardware or software depends on the specific application and design constraints of the technical solution. Professionals and technicians may use different methods for each specific application to implement the described functions, but such implementation should not be considered beyond the scope of the present disclosure.

In the embodiments provided in the present disclosure, it should be understood that the disclosed systems, apparatuses, and methods may be implemented in other ways. For example, the embodiments of the apparatus described above are merely illustrative. For example, the division of modules is only a logical function division, and there may be other division methods in actual implementation. For example, multiple modules or components may be combined or integrated into another system, or some features may be ignored or not executed. In addition, the mutual coupling or direct coupling or communication connection shown or discussed may be indirect coupling or communication connection through some interfaces, apparatuses, or modules, and may be in electrical, mechanical, or other forms.

The modules described as separate components may or may not be physically separated, and the components displayed as modules may or may not be physical modules, that is, may be located in one place, or may be distributed on multiple network units. Some or all of the modules may be selected according to actual needs to achieve the purpose of the solution of this embodiment. For example, the functional modules in some embodiments of the present disclosure may be integrated into one processing module, or each module may exist physically separately, or two or more modules may be integrated into one module.

The above are only specific implementations of the present disclosure, but the protection scope of the present disclosure is not limited thereto. Those skilled in the art can easily think of changes or substitutions within the technical scope disclosed in the present disclosure, which should be covered within the protection scope of the present disclosure. Therefore, the protection scope of the present disclosure shall be subject to the protection scope of the claims.

1. A processing method for equity incentive data, applied to a business server, comprising:
in response to a resource conversion request from a first terminal device, acquiring initial equity incentive data of a target object; wherein the initial equity incentive data comprises an initial option grant share and initial option vesting data under different vesting states; the initial option vesting data under different vesting states comprises an initial option vesting total share under a corresponding vesting state and initial option vesting sub-shares of different vesting batches;
acquiring conversion information corresponding to the resource conversion request, and converting the initial option grant share and initial option vesting total shares under different vesting states according to the conversion information, to obtain a target option grant share and target option vesting total shares under different vesting states;
for any target vesting state among the different vesting states, determining target option vesting sub-shares of different vesting batches, based on a target option vesting total share under the target vesting state, the initial option vesting sub-shares of different vesting batches, and the conversion information; and
sending the target option grant share and a target option vesting sub-share of each of the vesting batches under the different vesting states as target equity incentive data, to the first terminal device, and enabling the first terminal device to update the initial equity incentive data based on the target equity incentive data.

2. The processing method as claimed in claim 1, wherein the vesting states comprise a vested state, a to-be-vested state, and a to-be-vested cancelling state;
the converting the initial option grant share and initial option vesting total shares under different vesting states according to the conversion information, to obtain a target option grant share and target option vesting total shares under different vesting states, comprises:
converting the initial option grant share, an initial vested option total share under the vested state, and an initial to-be-vested cancelling option total share under the to-be-vested cancelling state according to the conversion information, to obtain the target option grant share, a target vested option total share under the vested state, and a target to-be-vested cancelling total option share under the to-be-vested cancelling state; and
obtaining a target to-be-vested state option total share under the to-be-vested state according to the target option grant share, the target vested option total share under the vested state, and the target to-be-vested cancelling total option share under the to-be-vested cancelling state.

3. The processing method as claimed in claim 2, wherein the initial option grant share is a sum of the initial vested option total share under the vested state and the initial to-be-vested cancelling option total share under the to-be-vested cancelling state.

4. The processing method as claimed in claim 2, wherein the equity incentive data comprises at least one of a RSU (Restricted Stock Unit) incentive equity and an OPTION incentive equity;
the converting the initial option grant share, an initial vested option total share under the vested state, and an initial to-be-vested cancelling option total share under the to-be-vested cancelling state according to the conversion information, to obtain the target option grant share, a target vested option total share under the vested state, and a target to-be-vested cancelling total option share under the to-be-vested cancelling state, comprises:
for the RSU incentive equity, the target option grant share is the initial option grant share divided by the stock consolidation ratio, wherein a result is rounded up; the target vested option total share under the vested state is the initial vested option total share under the vested state divided by the stock consolidation ratio, wherein a result is rounded up; the target to-be-vested cancelling total option share under the to-be-vested cancelling state is the initial to-be-vested cancelling option total share under the to-be-vested cancelling state divided by the stock consolidation ratio, wherein a result is rounded down;
for the OPTION incentive equity, the target option grant share is the initial option grant share divided by the stock consolidation ratio, wherein the result is rounded up; the target vested option total share under the vested state is the initial vested option total share under the vested state divided by the stock consolidation ratio, wherein the result is rounded down; the target to-be-vested cancelling total option share under the to-be-vested cancelling state is the initial to-be-vested cancelling option total share under the to-be-vested cancelling state divided by the stock consolidation ratio, wherein the result is rounded down.

5. The processing method as claimed in claim 2, wherein the target to-be-vested state option total share under the to-be-vested state is the target option grant share minus the target vested option total share under the vested state and the target to-be-vested cancelling total option share under the to-be-vested cancelling state.

6. The processing method as claimed in claim 2, wherein the initial vested option total share under the vested state comprises an initial exercised option share, an initial to-be-exercised option share, and an initial vested cancelled option share; the processing method further comprises:
converting the initial exercised option share and the initial to-be-exercised option share to obtain a target exercised option share and a target to-be-exercised option share based on the conversion information; and
obtaining a target vested cancelled option share corresponding to the initial vested cancelled option share according to the target vested option total share, the target exercised option share, and the target to-be-exercised option share.

7. The processing method as claimed in claim 1, wherein the determining target option vesting sub-shares of different vesting batches, based on a target option vesting total share under the target vesting state, the initial option vesting sub-shares of different vesting batches, and the conversion information, comprising:
for each initial option vesting sub-share of the previous (n−1) vesting batches, in a case where a quantity of vesting batches under the target vesting state is n, and n is greater than 1, converting the initial option vesting sub-shares, based on the conversion information to obtain target option vesting sub-shares of the previous (n−1) vesting batches; and
for an initial option vesting sub-share of an nth vesting batch, determining a target option vesting sub-share of the nth vesting batch, based on the target option vesting total share under the target vesting state and the target option vesting sub-shares of the previous (n−1) vesting batches.

8. The processing method as claimed in claim 2, wherein the processing method further comprises:
obtaining an initial to-be-vested state option quantity corresponding to the to-be-vested state from the initial option vesting total shares under the different vesting states; and
in a case where the initial to-be-vested state option quantity is 0, and the target option grant share is not equal to a sum of the target vested option total share under the vested state and the target to-be-vested cancelling total option share under the to-be-vested cancelling state, adjusting the target to-be-vested cancelling total option share under the to-be-vested cancelling state to obtain an adjusted to-be-vested cancelling option quantity, and enabling the target option grant share to be equal to the sum of the target vested option total share under the vested state and the target to-be-vested cancelling total option share under the to-be-vested cancelling state.

9. The processing method as claimed in claim 6, wherein the processing method further comprises:
in a case where the initial vested cancelled option share is 0, and the target vested option total share is not equal to a sum of the target exercised option share and the target to-be-exercised option share, adjusting the target vested cancelled option share, enabling the target vested option total share to be equal to the sum of the target exercised option share and the target to-be-exercised option share.

10. The processing method as claimed in claim 1, wherein the processing method further comprises:
determining whether the initial equity incentive data meets a preset condition, if yes, determining to the conversion information corresponding to the resource conversion request and converting the initial option grant share and the initial option vesting total shares under the different vesting states, based on the conversion information;
wherein the initial equity incentive data is considered to meet the preset condition in a case where the initial equity incentive data is in an effective state, and there is currently no pending review task, and options that have been determined to be vested have been allocated to corresponding employees.

11. An electronic device, comprising:
a processor; and
a memory, configured to store executable instructions of the processor;
wherein the processor is configured, via executing the executable instructions, to perform:
in response to a resource conversion request from a first terminal device, acquiring initial equity incentive data of a target object; wherein the initial equity incentive data comprises an initial option grant share and initial option vesting data under different vesting states; the initial option vesting data under different vesting states comprises an initial option vesting total share under a corresponding vesting state and initial option vesting sub-shares of different vesting batches;
acquiring conversion information corresponding to the resource conversion request, and converting the initial option grant share and initial option vesting total shares under different vesting states according to the conversion information, to obtain a target option grant share and target option vesting total shares under different vesting states;
for any target vesting state among the different vesting states, determining target option vesting sub-shares of different vesting batches, based on a target option vesting total share under the target vesting state, the initial option vesting sub-shares of different vesting batches, and the conversion information; and
sending the target option grant share and a target option vesting sub-share of each of the vesting batches under the different vesting states as target equity incentive data, to a first terminal device, and enabling the first terminal device to update the initial equity incentive data based on the target equity incentive data.

12. The electronic device as claimed in claim 11, wherein the vesting states comprise a vested state, a to-be-vested state, and a to-be-vested cancelling state;
the converting the initial option grant share and initial option vesting total shares under different vesting states according to the conversion information, to obtain a target option grant share and target option vesting total shares under different vesting states, comprises:
converting the initial option grant share, an initial vested option total share under the vested state, and an initial to-be-vested cancelling option total share under the to-be-vested cancelling state according to the conversion information, to obtain the target option grant share, a target vested option total share under the vested state, and a target to-be-vested cancelling total option share under the to-be-vested cancelling state; and
obtaining a target to-be-vested state option total share under the to-be-vested state according to the target option grant share, the target vested option total share under the vested state, and the target to-be-vested cancelling total option share under the to-be-vested cancelling state.

13. The electronic device as claimed in claim 12, wherein the equity incentive data comprises at least one of a RSU (Restricted Stock Unit) incentive equity and an OPTION incentive equity;
the converting the initial option grant share, an initial vested option total share under the vested state, and an initial to-be-vested cancelling option total share under the to-be-vested cancelling state according to the conversion information, to obtain the target option grant share, a target vested option total share under the vested state, and a target to-be-vested cancelling total option share under the to-be-vested cancelling state, comprises:
for the RSU incentive equity, the target option grant share is the initial option grant share divided by the stock consolidation ratio, wherein a result is rounded up; the target vested option total share under the vested state is the initial vested option total share under the vested state divided by the stock consolidation ratio, wherein a result is rounded up; the target to-be-vested cancelling total option share under the to-be-vested cancelling state is the initial to-be-vested cancelling option total share under the to-be-vested cancelling state divided by the stock consolidation ratio, wherein a result is rounded down;
for the OPTION incentive equity, the target option grant share is the initial option grant share divided by the stock consolidation ratio, wherein the result is rounded up; the target vested option total share under the vested state is the initial vested option total share under the vested state divided by the stock consolidation ratio, wherein the result is rounded down; the target to-be-vested cancelling total option share under the to-be-vested cancelling state is the initial to-be-vested cancelling option total share under the to-be-vested cancelling state divided by the stock consolidation ratio, wherein the result is rounded down.

14. The electronic device as claimed in claim 12, wherein the initial vested option total share under the vested state comprises an initial exercised option share, an initial to-be-exercised option share, and an initial vested cancelled option share; the electronic device further performs:
converting the initial exercised option share and the initial to-be-exercised option share to obtain a target exercised option share and a target to-be-exercised option share based on the conversion information; and
obtaining a target vested cancelled option share corresponding to the initial vested cancelled option share according to the target vested option total share, the target exercised option share, and the target to-be-exercised option share.

15. The electronic device as claimed in claim 11, the determining target option vesting sub-shares of different vesting batches, based on a target option vesting total share under the target vesting state, the initial option vesting sub-shares of different vesting batches, and the conversion information, comprising:
for each initial option vesting sub-share of the previous (n−1) vesting batches, in a case where a quantity of vesting batches under the target vesting state is n, and n is greater than 1, converting the initial option vesting sub-shares, based on the conversion information to obtain target option vesting sub-shares of the previous (n−1) vesting batches; and
for an initial option vesting sub-share of an nth vesting batch, determining a target option vesting sub-share of the nth vesting batch, based on the target option vesting total share under the target vesting state and the target option vesting sub-shares of the previous (n−1) vesting batches.

16. The electronic device as claimed in claim 12, wherein the electronic device further performs:
obtaining an initial to-be-vested state option quantity corresponding to the to-be-vested state from the initial option vesting total shares under the different vesting states; and
in a case where the initial to-be-vested state option quantity is 0, and the target option grant share is not equal to a sum of the target vested option total share under the vested state and the target to-be-vested cancelling total option share under the to-be-vested cancelling state, adjusting the target to-be-vested cancelling total option share under the to-be-vested cancelling state to obtain an adjusted to-be-vested cancelling option quantity, and enabling the target option grant share to be equal to the sum of the target vested option total share under the vested state and the target to-be-vested cancelling total option share under the to-be-vested cancelling state.

17. The electronic device as claimed in claim 14, wherein the electronic device further performs:
in a case where the initial vested cancelled option share is 0, and the target vested option total share is not equal to a sum of the target exercised option share and the target to-be-exercised option share, adjusting the target vested cancelled option share, enabling the target vested option total share to be equal to the sum of the target exercised option share and the target to-be-exercised option share.

18. The electronic device as claimed in claim 11, wherein the electronic device further performs:
determining whether the initial equity incentive data meets a preset condition, if yes, determining to the conversion information corresponding to the resource conversion request and converting the initial option grant share and the initial option vesting total shares under the different vesting states, based on the conversion information;
wherein the initial equity incentive data is considered to meet the preset condition in a case where the initial equity incentive data is in an effective state, and there is currently no pending review task, and options that have been determined to be vested have been allocated to corresponding employees.

19. The electronic device as claimed in claim 12, further comprising:
a transceiver, wherein the transceiver is connected to the processor or the memory.

20. A non-transitory computer storage medium, wherein a computer program is stored on the computer storage medium, wherein the computer program is executed by a processor to perform:
in response to a resource conversion request from a first terminal device, acquiring initial equity incentive data of a target object; wherein the initial equity incentive data comprises an initial option grant share and initial option vesting data under different vesting states; the initial option vesting data under different vesting states comprises an initial option vesting total share under a corresponding vesting state and initial option vesting sub-shares of different vesting batches;
acquiring conversion information corresponding to the resource conversion request, and converting the initial option grant share and initial option vesting total shares under different vesting states according to the conversion information, to obtain a target option grant share and target option vesting total shares under different vesting states;
for any target vesting state among the different vesting states, determining target option vesting sub-shares of different vesting batches, based on a target option vesting total share under the target vesting state, the initial option vesting sub-shares of different vesting batches, and the conversion information; and
sending the target option grant share and a target option vesting sub-share of each of the vesting batches under the different vesting states as target equity incentive data, to the first terminal device, and enabling the first terminal device to update the initial equity incentive data based on the target equity incentive data.
